(19) United States
(12) Patent Application Publication
(10) Pub. No.: US 2013/0036235 A1
(43) Pub. Date: Feb. 7, 2013

(54) METHOD OF TRANSMISSION OF VISUAL CONTENT

(71) Applicants: Pablo Lopez Garcia, Madrid (ES); Sergio Moreno Claros, Madrid (ES)

(72) Inventors: Pablo Lopez Garcia, Madrid (ES); Sergio Moreno Claros, Madrid (ES)

(21) Appl. No.: 13/641,482

(22) PCT Filed: Jun. 25, 2010
(86) PCT No.: PCT/EP10/59042

§ 371 Date: Oct. 22, 2012

(30) Foreign Application Priority Data
Apr. 16, 2010 (ES) P201030552

(51) Int. Cl. G06F 15/16

(52) U.S. Cl. 709/231

(57) ABSTRACT

A method of transmission of visual content over a communication network which locates static content and dynamic content, and transmits each type of content in a different way to optimize the transmission rate and the quality of the content received at the other end of the communication network.

### FIELD OF THE INVENTION

The present invention has its application within the telecommunications sector and, especially, in the field of content sharing.

### BACKGROUND OF THE INVENTION

Real time sharing of visual information over telecommunication networks is a widely used technique with applications in diverse fields, such as remote system managing, teleconferencing, or remote medical diagnosis. For example, it allows users to receive live video feed from a remote location to monitor activities or interact with other users, or to receive in a first computer information that would be normally displayed in the monitor of a second computer, thus allowing the user to remotely control said second computer.

There are two main ways of sharing visual information in real time:
Remote desktop solutions. These techniques treat all the visual information to be sent as a single static image. The full image is transmitted at the beginning of the transmission, and when a portion or the totality of said image changes, the resulting image (or image section) is transmitted again. Protocols like RDP (Remote Desktop Protocol) are related with this technique.
Video streaming solutions. In this case, the whole content is processed as a video frame and video encoding technologies are used to send the resultant video. The required bandwidth can be reduced by using video compression algorithms. An example of video streaming protocol is the H.239 protocol.

However, both solutions are designed for a specific type of content (images and video, respectively), and perform poorly when required to deal with the other type of content:
Video streaming solutions are designed for video transmissions and are thus not capable of sending static images with the high detail levels required in certain applications, such as, for example, remote medical diagnosis.
Remote desktop solutions have low refresh rates, which makes them inappropriate to deal with video feeds.

These limitations are especially problematic when dealing with mixed content (for example an screen comprising both videos and images which remain static for longer periods of time), as choosing any of the above options always results in either degrading the quality of static images or the refresh rate of video feeds.

### SUMMARY OF THE INVENTION

The current invention solves the aforementioned problems by disclosing a method of transmission of visual content which differentiates static content (for example, still images, or images with few changes over time) from dynamic content (such as video) and transmits each using a different technique. This way, the quality of the static content is optimized without increasing the required bandwith, and at the same time, videos are transmitted with an appropriate quality and refresh rate.

In a first aspect of the present invention, a method of transmission of visual content over a communication network is disclosed, the method comprising:
Detecting which part or parts of the visual content corresponds to static content (such as images), and which part corresponds to dynamic content (such as videos).
Transmitting each kind of content (static and dynamic) using different protocols, preferably remote desktop protocols for static content and video streaming for dynamic content.

The detection of static and dynamic content is preferably performed periodically, in order to detect alterations in said content (such as videos starting and ending, new applications displayed on a screen, etc).

Preferably, the step of detecting static content and dynamic content further comprises
(i) Detecting drawing operations performed by an operating system. According to two preferred options, this step is performed by monitoring system calls, or by using mirror video drivers.
(ii) Determining which areas of the frame that is to be displayed remotely are affected by said drawing operations. Preferably, the method considers rectangular areas, which are easier and faster to analyze and manipulate.
(iii) For each of the areas located in step (ii), the method determines if said area contains static or dynamic content. Preferably, the method takes into account an object class of the object drawn by the detected drawing operations, as some classes are more likely to result in dynamic or static content than others. Also preferably, this step is performed by computing a ratio or score which indicates a measure of the dynamism of the content of said area. The computed ratio is then compared to a threshold in order to differentiate static and dynamic content. This ratio preferably takes into account the totality or a subset of the following aspects of the area and the drawing operations performed on it:
   Number of drawing operations performed on the area, and size of the part of said area affected by the operations.
   Texting operations (that is, operations performed to display text) performed on the area.
   Refresh rate.
   Aspect ratio.
   Previous results of the dynamism ratio.

In another aspect of the present invention, a computer program which performs the described method is also disclosed.

Thus, the disclosed invention allows transmitting mixed visual content (containing both videos and images) over a communication network in real time without sacrificing the quality of neither static nor dynamic content. These and other advantages will be apparent in the light of the detailed description of the invention.

### BRIEF DESCRIPTION OF THE DRAWINGS

For the purpose of aiding the understanding of the characteristics of the invention, according to a preferred practical embodiment thereof and in order to complement this description, the following figures are attached as an integral part thereof, having an illustrative and non-limiting character:

FIG. 1 shows a schematic representation of the method of the invention according to one of its preferred embodiments.

FIG. 2 presents an example of application of the method in the field of telemedicine.

### DETAILED DESCRIPTION OF THE INVENTION

The matters defined in this detailed description are provided to assist in a comprehensive understanding of the invention. Accordingly, those of ordinary skill in the art will recognize that variation changes and modifications of the embodiments described herein can be made without departing from the scope and spirit of the invention.

Note that in this text, the term “comprises” and its derivations (such as “comprising”, etc.) should not be understood in an excluding sense, that is, these terms should not be interpreted as excluding the possibility that what is described and defined may include further elements, steps, etc.

Also, the term “visual content” refers to any information susceptible to be shown on a screen or any other display system, even if there is no active display showing said information. An example of visual content is the totality of information shown by the screen of a computer, but also the information shown in a given region of said screen, such as the window of an application, or said information codified in the computer when there is no screen displaying it. Finally, the terms “draw” and “drawing operation” refers to the action (or actions) performed by a computer or any other programmable hardware in order to display an information on a screen or any other display system.

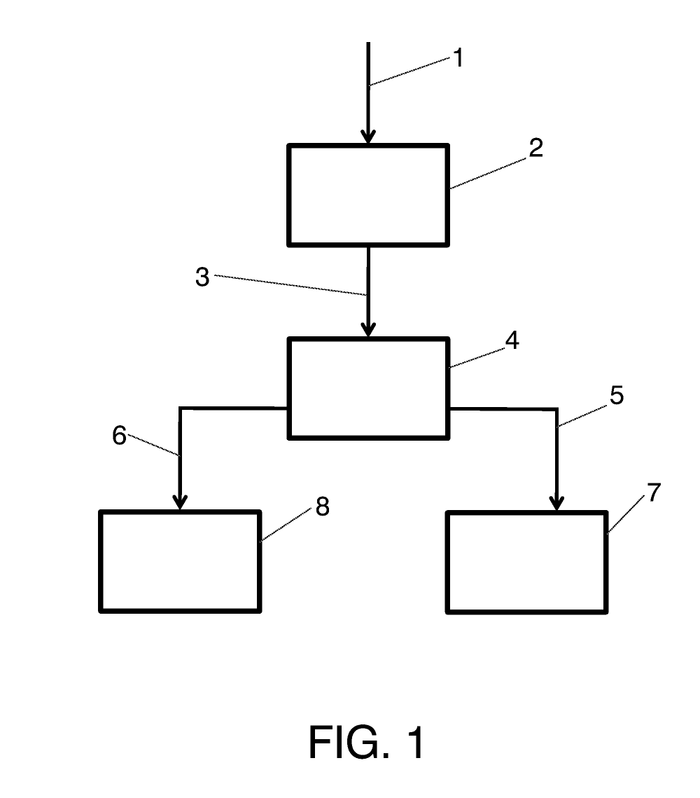

FIG. 1 shows a schematic representation of a particular embodiment of the method of the invention. As further described hereafter, drawing operations 1 are used to extract 2 statistical data 3 about the areas in which said drawing operations 1 take effect. The statistical data 3 is used to detect 4 static objects 5 and dynamic objects 6. Static content 5 is then transmitted using a first transmission mode 7, such as remote desktop protocols, and dynamic content 6 is transmitted using a second transmission mode 8, such as streaming video.

### Statistical Data Extraction

Drawing operations are analyzed and stored with the aim of obtaining simple statistical information about the drawing behaviors of the different applications in the computer. For each drawing operation the following information is extracted:
Rectangle that defines the bounds in the screen where the drawing operation is performed.
Class of drawing operation, which indicates if the operation corresponds to a image display or to texting.
The object that has issued the drawing operation.

This statistical data about the drawing operations can be obtained by the solution using different mechanisms, usually provide by the operating system like:
Mirror video drivers: Video drivers installed in the operating system that clone all the drawing operations done by the running applications in a internal storage that can be accessed by any other application to obtain the drawing statistical data. These drivers provide the drawing information instantly without delay.
Operating system calls monitoring: An operating system monitor is created to detect system calls associated to drawing operation. This method is usually slower as operating system calls need to read the graphic contents from the memory. This is a general method used by solutions without a specific mechanism to analyze the graphic information of the applications.

Regardless of the drawing operations detection mechanism used, said mechanism can either work on the totality of the video content (for example the totality of the screen), or only on the content associated to an active application. If the mechanism is working with the whole screen, all the statistical data is used. If the solution only works with the active application, part of the statistical data is discarded using this rule:
If the intersection of the rectangle that define the bounds of the drawing operation and the rectangle that define the bounds of the active applications is an empty intersection, the drawing operation is discarded.

It should be noted that the rest of this description refers to “active application”, although it is to be understood that all the explanations are equally valid for the case in which the visual information to be transmitted comprises a plurality of applications, such as the case in which the whole display of a computer is transmitted.

### Dynamic Object Detection

The extracted statistical data is used in a detection process to determine the dynamic parts of the active application:

1. The active application is analyzed and divided into objects (such as buttons, labels, boxes . . . ). For each visual object, the following attributes are stored:
a. Rectangle that defines the bounds of the object.
b. Object class: name that describes the kind of object in the operating system.
c. Any other descriptive attribute of the object assigned by the operating system.
   2. A first discrimination of the objects is performed according to their class:
Objects whose object classes usually have dynamic content (according to a predefined list which is built empirically), are directly detected as dynamic content.
Objects whose object classes never have dynamic content (for example, static controls such as buttons, list boxes, text editors, scroll bars, etc).
Additionally, objects which are smaller than a predefined dimension are also detected as static content.
   3. Then, all the statistic data about the drawing operations is processed to assign a score to each object. For each drawing operation, the following steps are performed:
a. If the object that has done the drawing operation is unknown, the rectangle that defines the bounds of the drawing operation is used to select the object that did the drawing operation. In an example, the object located in the centre of the rectangle is assigned to the drawing operation.
b. Each object is assigned a drawing counter, which is increased each time a drawing operating is assigned to the object.
c. Each object has a density counter that contains the total size of the drawing operations. For each drawing operation, the size of the operation is the area of the rectangle that defines the bounds of the operation. The value of this density counter is the addition of the area of all the drawing operations assigned to the object.
d. If the class of the drawing operation is texting, a penalty is added to the object assigned to the operation, as dynamic content are highly unlikely to perform texting operations.
   4. When all the statistic data is processed, an score is computed for each object of the active window. A preferred implementation of said score (and its threshold) is herein presented, although the weights and effects of the considered factors, as well of the selected factors themselves, can be varied in other particular embodiments.
a. The score is initially computed with the drawing counter and the density counter, according to this expression:

$$\frac{α \cdot density\_counter}{β \cdot drawing\_counter}$$

where α and β are parameters to determine the weights of the counters (in an exemplary embodiement, both (usually both α and β equeal 1). If the object has a penalty as result of the previous statistic data processing, the score is directly 0.
b. If the object was detected as a dynamic object in previous iterations of the solution, the score is multiplied by the number of consecutive times the object has been detected as dynamic. This way, objects known to be dynamic are rewarded.
c. A threshold is defined for each object to determine if the object has enough dynamism. This threshold depends of the area of the object (width×height), according with this expression:

χ·object_area

where χ is a weigh factor that allows to adjust the importance of the dynamism (for example ¼). If the score of the object is lower than the threshold, the object is discarded and detected as static content.
d. Dynamic objects must have a refresh rate similar to video content. The drawing counter and the repetition frequency of the detection process (for example once per second) are used to compute the refresh rate of the object. If the refresh rate is lower than a fixed value (for example 5 frames per second) the object is discarded and detected as static object. The refresh rate is calculated with the expression:

$$\frac{drawing\_counter}{repetition\_frequency}$$

e. Additionally, the score of the non discarded objects is penalized or rewarded according to the visual aspect of the object:
   If the aspect ratio (width/height) is similar to the most common video aspect ratios (16:9, 4:3 or 1:1) the score is increased.
   Other visual properties of the object provided for the operating system can be also compared to common properties of dynamic objects to increase or reduce its score. These properties depend on the operating system, being CS_VREDRAW and CS_HREDRAWN two example of properties of Windows systems which are valid for this task.
      6. Finally, all the objects that haven't been discarded in this process are detected as dynamic object and have a score that indicates the dynamism of the object.

Notice that the detection process is an iterative process that is constantly analyzing the objects of the active application, looking for dynamic content.

### Best Dynamic Object Selection

To reduce the amount of dynamic content to be sent and to focus the sharing in the most important dynamic object, it is possible to select only as dynamic content the object with the greatest score. As result of this selection, the others dynamic objects are then detected as static objects.

### Image Direct Access And Transmission

After the detection of static and dynamic content, different methods are used for its transmission.

Dynamic content is captured as a picture to be used as a video frame and encoded using any video codec (like H.264, VC-1 . . . ) and sent using any video streaming protocol (like RTP). Due to the common frame rate of videos (10-25 frames per second), the capture of the dynamic content as a picture must be fast. This is achieved by gaining direct access to a memory buffer with the whole screen picture through the video aforementioned video driver. The screen picture is cropped using the rectangle that defines the bounds of the dynamic object to obtain the picture of the dynamic object. Any video streaming algorithm can be used.

Static content is transferred using a remote desktop algorithm to maintain its detail, thus taking advantage of its low refresh rate. The portions of the static content that have changed are captured as pictures and sent as compressed image (usually JPEG compression, although any other is possible). Additional information, like the position of each modified portion, is sent to allow the reconstruction process in the receiver side. The first time the content is captured, the whole content is sent. In this case, a memory buffer with the whole screen picture is also accessed through the video driver. To avoid sending duplicated information, dynamic content can be cropped out when sending static content

The refresh rate of video streaming and remote desktop algorithms are independent of the rate of iteration of the detection process. The detection is usually done each second, whereas video rate is about 70-100 milliseconds (10-15 frames per second) and remote desktop rate is about 100-250 milliseconds.

Notice that the described method is equally valid for transmissions to a single receiver or to multiple receivers, as both video streaming and remote desktop support both point-to-point transmissions and multicasting.

The receiver of the information can visualizes the shared contents using the appropriate mechanisms to decode the different information he receives:
Video streaming: The dynamic content transmitted using video streaming, can be visualized using the correspondent video streaming player. As result, the receiver can visualize the dynamic content as a real video.
Remote desktop: The static content transmitted using remote desktop algorithms can be visualized drawing the pictures received in their correspondent locations. As result, the receiver can visualize the static content as a picture that is updated every time it changes.

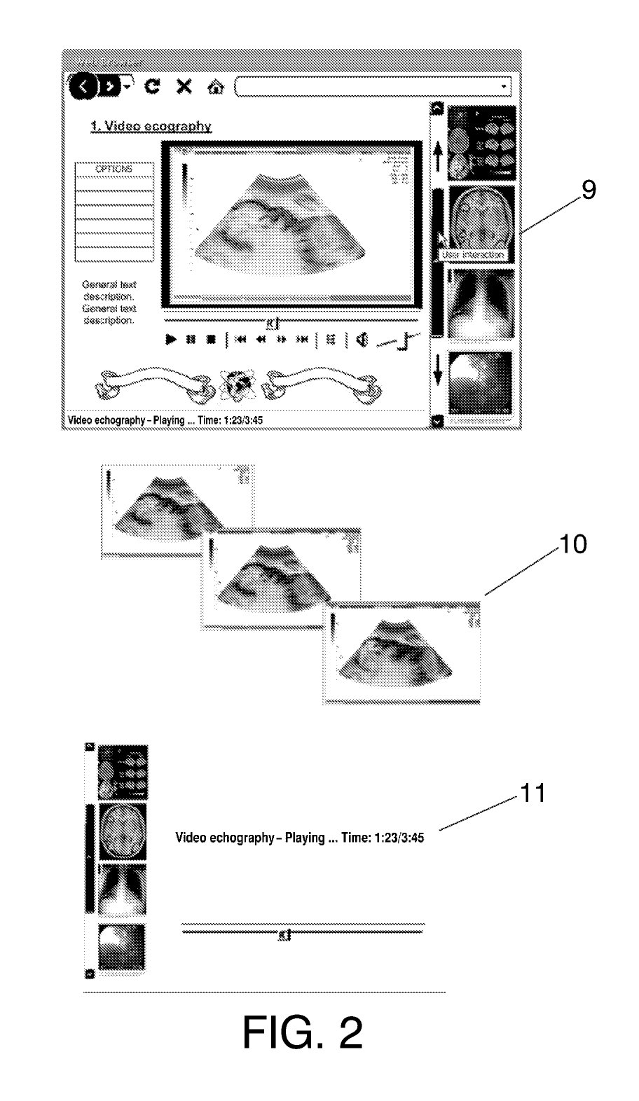

In FIG. 2, a particular embodiment of the method is applied to a remote diagnosis application 9. By applying the described steps, the visual content of the application is divided into dynamic content and static content. Then, the frames 10 of the dynamic content, and the images 11 which have changed are transmitted using the corresponding protocols.

1. A method of transmission of visual content over a communication network, wherein the method comprises:
detecting static content and dynamic content in the visual content;
transmitting the static content with a first transmission mode, and
transmitting the dynamic content with a second transmission mode.

2. The method according to claim 1 wherein the step of detecting static content and dynamic content is performed periodically.

3. The method according to claim 1 wherein the step of detecting static content and dynamic content further comprises:
(i) detecting drawing operations performed by an operating system;
(ii) locating areas where said drawing operations are performed; and
(iii) determining whether each area contains static content or dynamic content.

4. The method according to claim 3 wherein step (i) further comprises monitoring system calls of the operating system.

5. The method according to claim 3 wherein step (i) further comprises using mirror video drivers.

6. The method according to claim 3 wherein the areas have rectangular shape.

7. The method according to claim 3 wherein step (iii) further comprises determining an object class of an object drawn in an area.

8. The method according to claim 3 wherein step (iii) further comprises:
computing, for each area, a ratio measuring a likelihood of the area having dynamical content, the ratio being computed using statistical data of said area; and
comparing the computed ratio with a threshold.

9. The method according to claim 8 wherein the dynamism ratio of an area accounts a number of times a drawing operation is performed in said area and a size of a part of the modified by drawing operations.

10. The method according to claim 8 wherein the ratio of an area receives a penalty if a texting operation is detected in the area.

11. The method according to claim 8 wherein the ratio of an area accounts a refresh rate of the area.

12. The method according to claim 8 wherein the ratio of an area accounts an aspect ratio of the area.

13. The method according to claim 8 wherein the ratio of an area accounts previous values of the ratio of the area.

14. The method according to claim 1 wherein the first transmission mode is a video streaming method and the second transmission mode is a remote desktop method.

15. A computer program comprising computer program code means adapted to perform the steps of the method according to claim 1 when said program is run on a computer, a digital signal processor, a field-programmable gate array, an application-specific integrated circuit, a micro-processor, a micro-controller, or any other form of programmable hardware.
